(19) United States
(12) Patent Application Publication
(10) Pub. No.: US 2012/0235513 A1
(43) Pub. Date: Sep. 20, 2012

(54) DEVICE FOR SUPPLYING ELECTRIC POWER TO A MOBILE TELECOMMUNICATION EQUIPMENT, AND PORTABLE EQUIPMENT USING THE SAME

(75) Inventors: Cyrille Gachon, Saint Mercellin (FR); Daniel Ladret, Lans-en-Vercors (FR)

(73) Assignees: ST-ERICSSON (GRENOBLE) SAS, Grenoble (FR); ST-ERICSSON SA, Plan-les-Ouates (CH)

(21) Appl. No.: 13/497,794

(22) PCT Filed: Sep. 30, 2010
(86) PCT No.: PCT/EP2010/064597

§ 371 Date: Jun. 5, 2012

(30) Foreign Application Priority Data
Sep. 30, 2009 (FR) 0904675

(51) Int. Cl. H02B 1/24

(52) U.S. Cl. 307/126

(57) ABSTRACT

An electric power supply circuit that provides electric power to a mobile telecommunication device is provided. The electrical power supply circuit can be plugged in to a power grid or receive transformed energy from an alternate energy source. The electrical power supply circuit may provide converted electrical energy to a mobile telecommunication device from the power grid, the transformed energy or a rechargeable battery. Further, the electrical power supply can charge the rechargeable battery from either or both the electrical power grid or the transformed energy. A management module assesses the available electrical sources and the state of the electrical sources so as to switch an appropriate electrical power source to be input to the mobile telecommunication device.

### CROSS-REFERENCE TO RELATED APPLICATIONS

This application is a U.S. National Phase application submitted under 35 U.S.C. §371 of Patent Cooperation Treaty application serial no. PCT/EP2010/064597, filed Sep. 30, 2009, and entitled DEVICE FOR SUPPLYING ELECTRIC POWER TO A MOBILE TELECOMMUNICATION EQUIPMENT, AND PORTABLE EQUIPMENT USING THE SAME which application claims priority to French patent application serial no. 0904675, filed Sep. 30, 2009, and entitled DEVICE FOR SUPPLYING ELECTRIC POWER TO A MOBILE TELECOMMUNICATION EQUIPMENT, AND PORTABLE EQUIPMENT USING THE SAME.

Patent Cooperation Treaty application serial no. PCT/EP2010/064597, published as WO 2011/039326, and French patent application serial no. 0904675, are incorporated herein by reference.

### TECHNICAL FIELD

The invention relates to a device for supplying electric power to a mobile telecommunication equipment, for example, for a mobile phone or a laptop.

### SUMMARY

According to a first one of its aspects, the invention more particularly relates to a device for supplying electric power to a mobile telecommunication equipment comprising an electronic supply circuit comprising an input terminal designed to be plugged to the power grid, an output terminal adapted to be plugged to the portable equipment, a ground terminal electrically isolated from the input terminal, an electric power source arranged between the input and output terminals and adapted for supplying the portable equipment with electric power via the output terminal, the electric power source further being connected to the ground terminal and comprising a rechargeable battery for storing the electric power.

Such an electric power supplying device is well known by the skilled person to supply electric power, for example to a mobile phone. In view of the increasing electric power needs of mobile telecommunication equipments (and, particularly mobile phones which offer the user more and more services at the same time), a delicate compromise should be made between, on the one hand, the weight of the electric power source, and on the other hand, its capacity to restore electric power to supply said portable equipment.

Based on this original observation, the main object of the present invention is to propose a supply device which aims to reduce at least one of the previously mentioned limitations. To this end, the supply device, which still further conforms to the generic definition given in the preamble above, is substantially characterized in that it comprises a switching regulator comprising:
a servo switch comprising:
   a first commutator arranged between the input terminal and the electric power source, and
   a second commutator arranged between the electric power source and the output terminal,
a management module comprising a first terminal connected to the first commutator and a second terminal connected to the second commutator, the management module being adapted to assess a charge state of the rechargeable battery, and to drive the servo switch according to said charge state, the first commutator is adapted to direct the electric power coming from the input terminal among the electric power source and the first terminal, the second commutator being adapted to direct the electric power coming from the second terminal among the electric power source and the output terminal.

Thanks to these arrangements, it is possible to supply sufficient electric power to the portable equipment while minimizing the weight of the electric power source. This contributes in broadening the functional possibilities of the supply device according to the invention.

According to a second one of its aspects, the invention relates to a mobile telecommunication equipment using the supply device according to the invention.

### BRIEF DESCRIPTION OF THE DRAWINGS

Other characteristics and advantages of the invention will appear in the description which follows, made for an illustrative and non limitative purpose, with reference to the accompanying drawings in which:

FIG. 1 schematically represents a simplified view of a mobile telecommunication equipment comprising a device for supplying electric power according to an embodiment of the invention.

### DETAILED DESCRIPTION

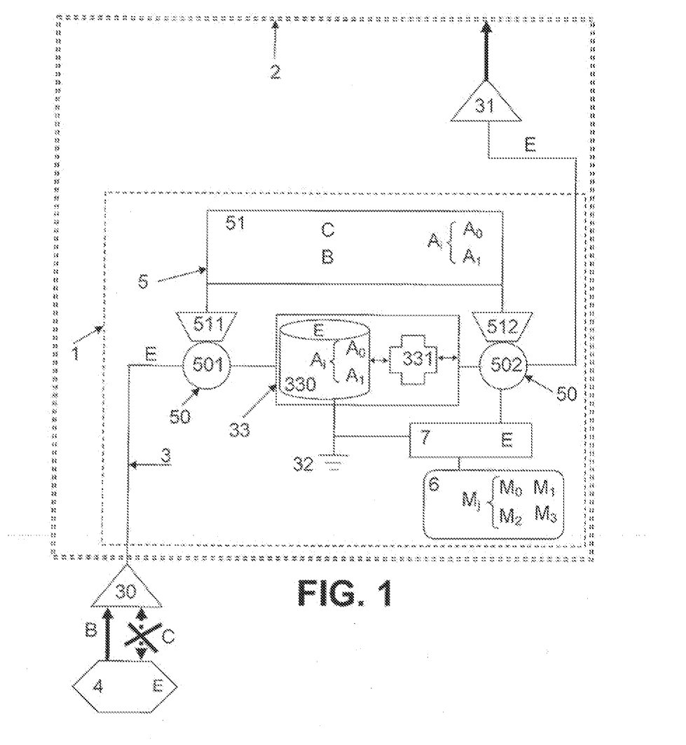

According to a first of its aspects, as previously mentioned and illustrated in FIG. 1, the invention relates to a device 1 for supplying electric power E to a mobile telecommunication equipment 2 (for example, for a mobile telephone or a laptop). This supply device 1 comprises an electronic supply circuit 3 comprising:
an input terminal 30 designed to be plugged to the power grid 4,
an output terminal 31 adapted to be plugged to the portable equipment 2,
a ground terminal 32 electrically isolated from the input terminal 30,
an electric power E source 33 arranged between the input and output terminals 30, 31 and adapted to supply the mobile equipment 2 with electric power E via the output terminal 31. The electric power E source 33 is further connected to the ground terminal 32 and comprises a rechargeable battery 330 adapted to store the electric power E.

According to an embodiment of the invention, the supply device 1 comprises a switching regulator 5 comprising:
a servo switch 50 comprising:
   a first commutator 501 arranged between the input terminal 30 and the electric power E source 33, and
   a second commutator 502 arranged between the electric power E source 33 and the output terminal 31,
a management module 51 comprising a first terminal 511 connected to the first commutator 501 and a second terminal 512 connected to the second commutator 502, the management module 51 being adapted to assess a charge state Aᵢ of the rechargeable battery 330, and to drive the servo switch 50 according to said charge state A_{i,} the first commutator 501 being adapted to direct the electric power E coming from the input terminal 30 among the electric power E source 33 and the first terminal 511, the second commutator 502 being adapted to direct the electric power E coming from the second terminal 512 among the electric power E source 33 and the output terminal 31.

Preferably, the management module 51 is adapted to assess an active connection state B between the input terminal 30 and the power grid 4. When, on the one hand, the connection between the input terminal 30 and the power grid 4 exhibits the active state B (that is to say, when the input terminal 30 is plugged to the power grid 4) and, on the other hand, the rechargeable battery 330 exhibits the charge state Aᵢ corresponding to the rechargeable battery 330 full charge A₀ (that is to say, Ai=A0), the servo switch 50 is adapted to supply the electric power E to the output terminal 31 from the input terminal 30 by bypassing the electric power E source 33 (for example, by passing through the management module 51 via the first and second terminals 511, 512).

Thanks to these arrangements, the supply device 1 is capable of supplying the mobile telecommunication equipment 2 with electric power E directly from the power grid 4 (without passing through the electric power E source 33). This tends to reduce a number of “charged/uncharged” cycles of the rechargeable battery 330 thus contributing to increase its service life.

Advantageously, the management module 51 is adapted, as specified above, to assess the active connection state B between the input terminal 30 and the power grid 4. When, on the one hand, the connection between the input terminal 30 and the power grid 4 exhibits the active state B and, on the other hand, the rechargeable battery 330 exhibits the charge state Aᵢ corresponding to the rechargeable battery 330 incomplete charge A₁ (that is to say, Aᵢ=A₁), the servo switch 50 is adapted to supply the electric power E from the input terminal 30, to both the output terminal 31 and to the electric power E source 33.

Thanks to these arrangements, the supply device 1 is capable of supplying the mobile telecommunication equipment 2 with electric power E directly from the power grid (without passing through the electric power E source 33) while recharging the rechargeable battery 330. This makes it possible to maintain the supply of the mobile telecommunication equipment 2 during the charging of the rechargeable battery 330. This contributes in broadening the functional possibilities of said supply device 1.

Preferably, the management module 51 is adapted to assess an interrupted connection state C between the input terminal 30 and the power grid 4. When the connection between the input terminal 30 and the power grid 4 exhibits the interrupted state C (that is to say, when the input terminal 30 is unplugged from the power grid 4), the servo switch 50 is adapted to supply electric power E to the output terminal 31 from the electric power E source 33.

Thanks to these arrangements, everything being unplugged from the power grid 4, the supply device 1 is able to supply the mobile telecommunication equipment 2 with electric power E. This contributes in broadening the functional possibilities of said supply device 1.

Advantageously, the supply device 1 may comprise at least one auxiliary power Mⱼ capturing module 6 adapted to detect the auxiliary power Mⱼ and a transformation module 7 connected to the capturing module 6 and adapted to transform the auxiliary power Mⱼ (provided by the capturing module 6 to the transformation module 7) into electric power E. The transformation module 7 is further mounted in parallel on the electric power E source 33 between the ground terminal 32 and the second terminal 512. The second commutator 502 is adapted to direct the electric power E coming from the transformation module 7 towards the electric power E source 33 and/or towards the output terminal 31.

Thanks to these arrangements, the supply device 1 is more environment-friendly as it can transform into electric power E, the auxiliary energy Mⱼ, preferably, of “renewable energy” type, thus contributing, in fine, to reduce greenhouse gases.

Advantageously, when the connection between the input terminal 30 and the power grid 4 exhibits the interrupted state C, the servo switch 50 is adapted to supply electric power E to the output terminal 31 via the second commutator 502, at the same time, from the transformation module 7 and from the electric power E source 33.

Thanks to these arrangements, the supply device 1 ensures the mobile telecommunication equipment 2 greater operating autonomy of in the absence of the power grid 4. In fact, at least one part of the electric power E is supplied to the mobile telecommunication equipment 2 from the transformation module 7, thus contributing to reduce as much the depletion of the rechargeable battery 330 (and which can, due to this fact, remain in working order for longer).

Preferably, when, on the one hand, the connection between the input terminal 30 and the power grid 4 exhibits the interrupted state C, and on the other hand, the rechargeable battery 330 exhibits the charge state Aᵢ corresponding to the rechargeable battery 330 incomplete charge A1, the servo switch 50 is adapted to supply the electric power E from the transformation module 7, to both the output terminal 31 and to the electric power E source 33.

Thanks to these arrangements, it is possible to use the auxiliary power Mⱼ to recharge the rechargeable battery 330 in absence of the power grid 4 (for example, in disaster areas during environmental phenomenon such as earthquakes, tsunamis, etc.). Thus, the supply device 1 may be used by the emergency services to recharge the depleted rechargeable battery 330, thus contributing, in fine, in saving human lives.

Advantageously, the servo switch 50 is further adapted to supply the electric power E to the output terminal 31 from the transformation module 7. This embodiment is particularly appropriate for the case described above when the management module 51 is adapted to assess the active connection state B between the input terminal 30 and the power grid 4. When, on the one hand, the connection between the input terminal 30 and the power grid 4 exhibits the active state B (that is to say, when the input terminal 30 is plugged to the power grid 4) and, on the other hand, the rechargeable battery 330 exhibits the charge state Aᵢ corresponding to the rechargeable battery 330 full charge A₀ (that is to say, Aᵢ=A₀), the servo switch 50 is adapted to supply the electric power E to the output terminal 31 from the input terminal 30 by bypassing the electric power E source 33 (for example, by passing through the management module 51 via the first and second terminals 511, 512).

Thanks to these arrangements, the output terminal 31 may be supplied in a hybrid manner, at the same time, by the transformation module 7 (of renewable type of electric power E) and by the power grid 4 (of non renewable type of electric power E, for example fossil). This contributes in making the supply device 1 more environment-friendly.

Preferably, the servo switch 50 is further adapted to supply electric power E, at the same time, to the output terminal 31 and to the electric power E source 33 from the transformation module 7. This embodiment is particularly adapted to the case described above when the management module 51 is adapted to assess the active connection state B between the input terminal 30 and the power grid 4. When, on the one hand, the connection between the input terminal 30 and the power grid 4 exhibits the active state B, and on the other hand, the rechargeable battery 330 exhibits the charge state Aᵢ corresponding to the rechargeable battery 330 full charge A1 (that is to say, Aᵢ=A₁), the servo switch 50 is adapted to supply the electric power E from the input terminal 30, to both the output terminal 31 and to the electric power E source 33.

Thanks to these arrangements, the output terminal 31 and the rechargeable battery 330 may be supplied in a hybrid manner, at the same time by the transformation module 7 (of renewable energy type electric power E) and by the power grid 4 (of non renewable type of electric power E, for example fossil). This contributes in making the supply device 1 more environment-friendly.

Preferably, the capturing module 6 is adapted to detect at least one amongst the following auxiliary energies Mⱼ: (a) solar energy M0; (b) thermal energy M1; (c) kinetic energy M₂; (d) radio wave energy M₃.

Thanks to these arrangements, the supply device 1 is more environment-friendly as it can transform into electric power E, the solar energy M₀, and/or the thermal energy M₁, and/or the kinetic energy M₂, and/or radio wave energy M₃. Furthermore, this contributes in broadening the functional possibilities of said supply device 1, particularly, during the use of the supply device 1 by the emergency services in disaster areas.

Advantageously, the electric power E source 33 comprises a linear charger 331 adapted to make the electric power E entering the electric power E source 33 pass towards the rechargeable battery 330 or exiting the electric power E source 33 from the rechargeable battery 330.

This simplifies the use of the supply device 1 on a daily basis and contributes in increasing the service life of the rechargeable battery 330 by the fact of the temporal linearization of its “charged/uncharged” cycles.

According to a second aspect, the invention relates to the mobile telecommunication equipment 2 using the supply device 1 according to the invention.

Preferably, the supply device is integrated within the mobile telecommunication equipment 2.

This facilitates the use of the mobile telecommunication equipment 2 on a daily basis, particularly during emergency situations where it is necessary to reduce the risk of loss of the supply device 1.

Alternatively, (case not shown), the supply device 1 may be linked to the mobile telecommunication equipment 2 using a linking means (not shown), for example, using an electric wire.

Thanks to these arrangements, it becomes easier to handle the supply device 1 in space, for example, to orient more precisely the capturing module 6 opposite the sun.

1-12. (canceled)

13. An electric power supplying device for a mobile telecommunication equipment comprising:
an electronic supply circuit comprising:
an input terminal adapted to be connected to a power grid;
an output terminal adapted to be connected to the mobile telecommunication equipment;
a ground terminal electrically isolated from the input terminal;
an electric power source, arranged between the input terminal and the output terminal, adapted to supply the mobile telecommunication equipment with electric power via the output terminal, the electric power source being further connected to the ground terminal and comprising a rechargeable battery adapted to store electrical power;
a switching regulator comprising:
a servo switch comprising:
a first commutator arranged between the input terminal and the electric power source; and
a second commutator arranged between the electric power source and the output terminal; and
a management module comprising a first terminal connected to the first commutator and a second terminal connect to the second commutator, the management module being adapted to assess a charge state of the rechargeable battery and to drive the servo switch according to the charge state;
wherein the first commutator is adapted to direct the electric power coming from the input terminal among the electric power source and the first terminal and the second commutator is adapted to direct the electric power coming from the second terminal among the electric power source and the output terminal.

14. The electric power supply device of claim 13, wherein the management module is adapted to assess an active connection state between the input terminal and the power grid such that when the connection between the input terminal and the power grid exhibits the active connection state and the rechargeable battery exhibits a full charge state, the servo switch is adapted to supply the electric power to the output terminal from the input terminal by bypassing the electric power source.

15. The electric power supply device of claim 13, wherein the management module is adapted to assess an active connection state between the input terminal and the power grid, such that when the connection between the input terminal and the power grid exhibits the active connection state and the rechargeable battery exhibits an incomplete charge state, the servo switch is adapted to supply the electric power from the input terminal to both the output terminal and the electric power source.

16. The electric power supply device of claim 13, wherein the management module is adapted to assess an interrupted connection state between the input terminal and the power grid, such that when the connection between the input terminal and the power grid exhibits the interrupted state, the servo switch is adapted to connect electric power to the output terminal from the electric power source.

17. The electric power supply device of claim 13, further comprising:
an auxiliary energy capturing module adapted to collect auxiliary energy; and
a transformation module, connected to the auxiliary energy capturing module, adapted to transform the auxiliary energy into electrical power, the transformation module being further mounted in parallel with the electrical power source between the ground terminal and the second terminal;
wherein the second commutator is adapted to direct the electric power coming from the transformation module to the electric power source or towards the output terminal.

18. The electric power supply device of claim 17, wherein the management module is adapted to assess an interrupted connection state between the input terminal and the power grid, such that when the connection between the input terminal and the power grid exhibits the interrupted state, the servo switch is adapted to connect the transformation module and the electric power source to provide electric power to the output terminal.

19. The electric power supply device of claim 17, wherein the management module is adapted to assess an interrupted connection state between the input terminal and the power grid, such that when the connection between the input terminal and the power grid exhibits the interrupted state and the rechargeable battery exhibits a charge state corresponding to the rechargeable battery having an incomplete charge, the servo switch is adapted to connect electrical power from the transformation module to both the output terminal and the electric power source.

20. The electric power supply device of claim 17, wherein the management module is adapted to assess an active connection state between the input terminal and the power grid, such that when the connection between the input terminal and the power grid exhibits the active connection state and the rechargeable battery exhibits a full charge state, the servo switch is adapted to supply electrical power to the output terminal form the transformation module.

21. The electric power supply device of claim 17, wherein the management module is adapted to assess an active state or interrupted state connection state between the input terminal and the power grid, such that when the connection between the input terminal and the power grid exhibits either an active connection state or interrupted state connection and whether the rechargeable battery exhibits a full or incomplete charge state, the servo switch is adapted to connect the transformation module to at least the output terminal and provide electrical power from the transformation module to at least the output terminal.

22. The electric power supply device of claim 17, wherein the auxiliary energy capturing module is adapted to detect an availability of at least one of solar energy, thermal energy, kinetic energy, and radio wave energy.

23. The electric power supply device of claim 17, wherein the electrical power source further comprises a linear charger adapted to charge the rechargeable battery with electrical power provided from the input terminal or the transformation module, and wherein the linear charger is further adapted to provide electrical power from the rechargeable battery toward the output terminal when the rechargeable battery is not being charged.

24. The electric power supply device of claim 17, wherein the electric power supply device is an integral part of the mobile telecommunication equipment.
